(19) United States
(12) Patent Application Publication
(10) Pub. No.: US 2019/0249040 A1
(43) Pub. Date: Aug. 15, 2019

(54) LOW-OUTGASSING ADHESIVE TAPE FOR WRAPPING ELONGATED OBJECT

(71) Applicant: certoplast Vorwerk & Sohn GmbH, Wuppertal (DE)

(72) Inventors: Timo LEERMANN, Wuppertal (DE); Peter RAMBUSCH, Wuppertal (DE); Rene RAMBUSCH, Wuppertal (DE)

(21) Appl. No.: 15/745,564

(22) PCT Filed: Jul. 13, 2016
(86) PCT No.: PCT/EP2016/066668

§ 371 Date: Apr. 23, 2018

(30) Foreign Application Priority Data
Aug. 13, 2015 (DE) 20 2015 104 283.3

(51) Int. Cl. C09J 109/06; C09J 7/35; C09J 115/00; C09J 7/21

(52) U.S. Cl. CPC C09J 109/06; C09J 7/35; C09J 115/00; C09J 7/21; C09J 2203/302; C09J 2431/00; C09J 2409/00; C09J 2467/006; C09J 2477/006; C09J 2411/00; C09J 2415/00; C09J 2400/263

(57) ABSTRACT

The object of the invention is a low-fogging adhesive tape for enveloping elongated objects, in particular a low-fogging wrapping tape for bundling cables in automobiles. The latter has a support and an adhesive coating on at least one side of the support. According to the invention, a synthetic-rubber-based coating is used as the adhesive coating.

The invention relates to a low-outgassing adhesive tape for wrapping an elongated object, particularly a low-outgassing wrapping tape for bundling cables in automobiles, with a substrate, and with an adhesive coating on at least one face of the substrate.

Adhesive tape for wrapping an elongated object and particularly wrapping tapes for bundling cables in automobiles are known in a variety of forms from practice and printed publications. The question of outgassing behavior is increasingly becoming an issue, which is why low-outgassing adhesive tapes such as those described in the category-defining EP 0 937 771 are being pursued.

This involves a non-outgassing adhesive tape that is manufactured from a substrate and a pressure-sensitive adhesive compound that is based on an acrylate hot melt. No complete absence of outgassing is however observed. The term “fogging” is used generally to refer to the condensation of volatile components particularly from the vehicle interior trim on glass panes and usually on the windshield. Such fogging behavior is also observed with adhesive tapes for wrapping an elongated object and particularly for bundling cables in automobiles and regarded as similarly disadvantageous as the condensation of volatile components of the vehicle interior trim.

For this reason, various approaches have been taken in the past to optimizing the outgassing behavior of such adhesive tapes with the aim of eliminating outgassing or bringing it down to a low level. The so-called outgassing value G or condensable component G according to DIN 75 201 is usually used to assess the outgassing behavior. In the variant according to process B which is of interest here, the outgassing value G is determined such that a test specimen of the specimen adhesive tape, along with its volatile components, is exposed to a defined amount of heating for a predefined period of time. The components that then precipitate on an aluminum foil can then be detected gravimetrically by weighing the foil before and after the fogging test.

While the known teaching according to EP 0 937 761 [U.S. Pat. No. 6,432,529] speaks here of an overall non-outgassing self-adhesive tape, residues are still observed in the determination of the outgassing value G, so reference will be made hereinafter in this regard and overall as well to a low-outgassing adhesive tape.

Thus, in order to achieve the required low outgassing characteristic and hence a low outgassing value G, the use of acrylate hot melt-based adhesive compound is emphasized in the context of EP 0 937 761 as well as in parallel applications of the same applicant. In fact, it is believed that an especially small component of volatile components can only be ensured by using such an adhesive compound, especially since the application of these adhesive compounds is performed without solvent.

While the acrylate hot-melt adhesive compound that is used in practice and in the literature can be easily applied to the substrate, it requires subsequent cross-linking. Cross-linking is typically performed by radiochemical means in this context using UV rays. Consequently, UV emitters are inevitably required in the web run and during the manufacture of the adhesive tape. This results in substantial equipment-related expenses. It is in this regard that the invention aims to provide a remedy.

The object of the invention is to further develop a low-outgassing adhesive tape such that the manufacturing costs are reduced and, accordingly, reduced production costs can be expected.

In order to attain this object, a generic low-outgassing adhesive tape for wrapping an elongated object and particularly a low-outgassing wrapping tape for wrapping cables in automobiles is characterized in the context of the invention in that a synthetic rubber-based adhesive coating is used.

Unlike the prior art, particularly that according to EP 0 937 761, the teaching of the invention therefore does not make use of an acrylate hot-melt adhesive coating that must unavoidably be cross linked using UV rays, but rather uses an adhesive coating that is based on synthetic rubber instead. The application of the synthetic rubber-based adhesive coating can be performed in a manner that is comparable to the procedure used for the acrylate hot-melt adhesive compound according to EP 0 937 761, namely without solution and directly with the aid of a heated nozzle. Unlike the prior art, however, a subsequent radiochemical cross-linking is omitted.

Instead, cross-linking is normally not required in the synthetic rubber-based adhesive coating used according to the invention. This means that the additional, costly equipment that is inevitably required in the form of UV emitters in the prior art according to EP 0 937 761 can be expressly dispensed with. As a consequence of this, the equipment-related expenses can be reduced, and processing can be performed especially quickly overall in consideration of a compact construction.

The adhesive coating itself is typically composed of a thermoplastic elastomer or synthetic rubber and an adhesive resin. Both the elastomer and the adhesive resin can each be present as material mixtures. The procedure for manufacturing the adhesive coating is usually such that the thermoplastic elastomer is heated up and added to the adhesive resin. This can be done statically in a vessel with simultaneous stirring or also dynamically in an extruder.

The adhesive resin can be present in the adhesive coating in a grammage from 20 wt % to 70 wt %. For the thermoplastic elastomer, a proportion by weight of 30 to 80 wt % is observed in the adhesive coating, although additives such as oil may also have to be taken into account in the adhesive coating.

Moreover, it is especially advantageous if an adhesive resin is used which, at temperatures above room temperature up to 100° C. or even more, no longer has any volatile condensable components. In this way, especially low levels of outgassing and outgassing are observed in the adhesive coating, and hence a low outgassing value and a low condensable component G as well. In fact, gravimetric outgassing values G for the entire inventive and low-outgassing adhesive tape of less than 3 mg and preferably of less than 1.5 mg have been observed for a test specimen having a surface area of about 50 cm².

In this context, the approach taken by the invention is to determine the gravimetric outgassing value G in question according to DIN 75 201, process B. That is, the above-mentioned test specimen having a surface area of about 50 cm² is applied to the bottom of a glass beaker without a spout. The test specimen is a punched-out flat piece of the adhesive tape according to the invention with the substrate and the adhesive coating on only one face of the substrate. The beaker is then covered with aluminum foil on which volatile components from the test specimen can condense. The aluminum foil is cooled for this purpose.

The beaker prepared in this way is then heated for a period of 16 hours in a liquid bath. The test temperature is about 100° C. After the test program described above, the mass of the outgassing precipitate on the aluminum foil is determined quantitatively by comparing the weigh of the foil in question before and after the outgassing test.

At any rate, it was found that, with the synthetic rubber-based adhesive coating according to the invention, levels were observed for the outgassing value G that are comparable to those cited in EP 0 937 761, for example, and are incorrectly termed non-outgassing overall while they are in fact low-outgassing. All of this is achieved with a reduced equipment setup and thus with reduced manufacturing costs. This can be attributed essentially to the fact that a cross-linking of the adhesive coating following the nozzle application on the substrate is usually not necessary. Herein lie the fundamental advantages.

According to an advantageous embodiment, the adhesive coating generally has an application weight of 20 g/m² to 300 g/m². The substrate can be any suitable substrate in principle. A textile substrate is preferred. In fact, the invention makes use predominantly of nonwoven substrates or fabric substrates, because such substrates generally have an especially favorable outgassing behavior and/or exhibit practically no outgassing at all in the described outgassing test and therefore do not contribute to the gravimetric outgassing value G de facto. This can be attributed essentially to the fact that the substrate is constructed preponderantly from polyester yarns and/or polyester filaments or also polyester fibers. Alternatively or in addition, however, one can in principle also use polyamide yarns and/or polyamide filaments or also polyamide fibers that have practically no volatile components overall at the temperature of about 100° C. that is employed.

The gravimetric outgassing value G of the low-outgassing adhesive tape according to the invention is thus fed primarily by volatile components of the synthetic rubber-based adhesive coating. What is more, since the quantity of condensate given off usually depends on the surface area and/or coverage with the adhesive coating, according to an advantageous embodiment of the invention the adhesive coating is applied over the entire surface or as a stripe coating to one or both faces of the substrate. Particularly in the case of a stripe coating, it can be expected that the above-mentioned gravimetric outgassing values G for the adhesive tape according to the invention will be undershot substantially, with it being possible for gravimetric outgassing values G of far lower than 1 mg to be observed for the above-mentioned test specimen having a surface area of about 50 cm², for example.

The adhesive coating as such can have silicone rubber, fluororubber, styrene-butadiene rubber, polybutadiene rubber, nitrile rubber, chloroprene rubber, styrene-isoprene rubber, ethylene vinyl acetate, or also ethylene propylene diene rubber as its base, either individually or in combination. The previously described adhesive resin is then also added to this thermoplastic elastomer or synthetic rubber. The elastomer is typically prepared synthetically through polymerization, in which case the polymer chains are constructed from hydrocarbons or on the basis of silicones. The addition of adhesive resin to the thermoplastic elastomer is performed through heating as described above.

The following adhesive resins have proven to be especially favorable and low-outgassing. Aliphatic hydrocarbon resins, aromatic hydrocarbon resins, alkyl aromatic hydrocarbon resins, hydrocarbon resins based on pure monomers, hydrated hydrocarbon resins, terpene resins, functional hydrocarbon resins, and natural resins, each individually or in combination. In fact, in combination with the previously indicated thermoplastic elastomers and/or the synthetic rubber, these resins exhibit particularly low values for outgassing and the previously described outgassing value G and are consequently as if predestined for the described application.

1. A low-outgassing adhesive wrapping tape for bundling cables in automobiles, the tape comprising:
a substrate having opposite faces, and
a synthetic rubber-based adhesive coating on at least one of the faces of the substrate.

2. The adhesive tape defined in claim 1, wherein the coating comprises at least one thermoplastic elastomer and one adhesive resin.

3. The adhesive tape defined in claim 2, wherein the adhesive resin in the adhesive coating makes up a proportion of 20 to 70 wt % and the thermoplastic elastomer a proportion of 30 to 80 wt %.

4. The adhesive tape defined in claim 2, wherein the adhesive resin, at temperatures above room temperature up to 100° C. or more, no longer has any volatile condensable components.

5. The adhesive tape defined in claim 1, wherein the adhesive coating is applied over the entire surface or as a stripe coating to one or both faces of the substrate.

6. The adhesive tape defined in claim 1, wherein the adhesive coating has an application weight of 20 g/m² to 300 g/m².

7. The adhesive tape defined in claim 1, wherein the substrate is a textile substrate constructed from polyester yarns and polyester fibers or polyamide yarns and/or polyamide fibers.

8. The adhesive tape defined in claim 7, wherein the substrate is a nonwoven substrate or fabric substrate.

9. The adhesive tape defined in claim 8, wherein the substrate is chemically and/or mechanically compacted.

10. The adhesive tape defined in claim 1, wherein a gravimetric outgassing value G of less than 3 mg is observed for a test specimen of about 50 cm².

11. The adhesive tape defined in claim 10, wherein the gravimetric outgassing value G is determined according to DIN 75 201, process B.

12. The adhesive tape defined in claim 1, wherein silicone rubber, fluororubber, styrene-butadiene rubber, polybutadiene rubber, nitrile rubber, chloroprene rubber, styrene-isoprene rubber, ethylene vinyl acetate, and ethylene propylene diene rubber, either individually or in combination, are a base for the adhesive coating.

13. The adhesive tape defined in claim 2, wherein aliphatic hydrocarbon resins, aromatic hydrocarbon resins, alkyl aromatic hydrocarbon resins, hydrocarbon resins based on pure monomers, hydrated hydrocarbon resins, terpene resins, functional hydrocarbon resins, and natural resins, individually or in combination, are used as the adhesive resin.
